(19) United States
(12) Patent Application Publication
(10) Pub. No.: US 2025/0011693 A1
(43) Pub. Date: Jan. 9, 2025

(54) BIODEGRADABLE DRYER SHEET

(71) Applicant: Tyler Little, Harvard, IL (US)

(72) Inventor: Tyler Little, Harvard, IL (US)

(21) Appl. No.: 18/218,985

(22) Filed: Jul. 6, 2023

(51) Int. Cl. C11D 17/04; C11D 3/00; C11D 3/30; C11D 3/382; C11D 3/48; C11D 11/00

(52) U.S. Cl. CPC C11D 17/047; C11D 3/001; C11D 3/30; C11D 3/382; C11D 3/48; C11D 2111/12

(57) ABSTRACT

A dryer sheet for softening fabrics with biodegradable substances includes a substrate, a fabric softening agent coupled to the substrate, and an antibacterial agent coupled to the substrate. Each of the substrate, the fabric softening agent, and the antibacterial agent are biodegradable.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dryer sheet and more particularly pertains to a new dryer sheet for softening fabrics with biodegradable substances.

### (2) Description of Related Art Including Information Disclosed Under 37 CFR 1.97 and 1.98

The prior art describes biodegradable dryer sheets such as ones formed of a wood- or cellulose-fiber substrate and tallow- or vegetable-sourced quaternary ammonium compounds. However, the prior art fails to describe such a dryer sheet which includes antibacterial substances and a substrate formed of cotton, bamboo, or the like. Such a composition imparts additional antibacterial properties onto laundered fabrics over the prior art and provides alternative substrate compositions to that of the prior art.

### BRIEF SUMMARY OF THE INVENTION

An embodiment of the disclosure meets the needs presented above by generally comprising a substrate, a fabric softening agent coupled to the substrate, and an antibacterial agent coupled to the substrate. Each of the substrate, the fabric softening agent, and the antibacterial agent are biodegradable.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dryer sheet according to an embodiment of the disclosure.

FIG. 2 is an in-use view of an embodiment of the disclosure.

### DETAILED DESCRIPTION OF THE INVENTION

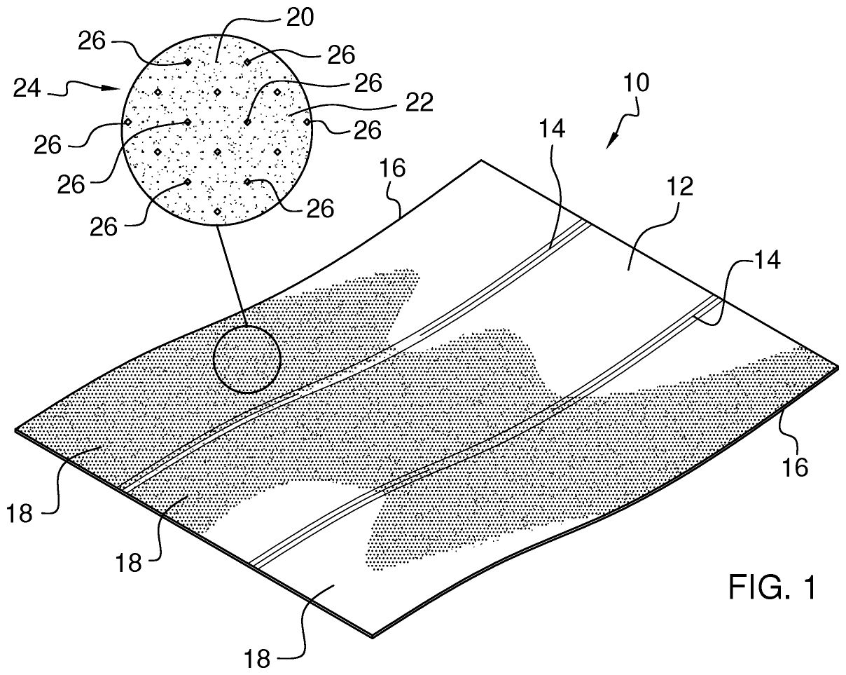

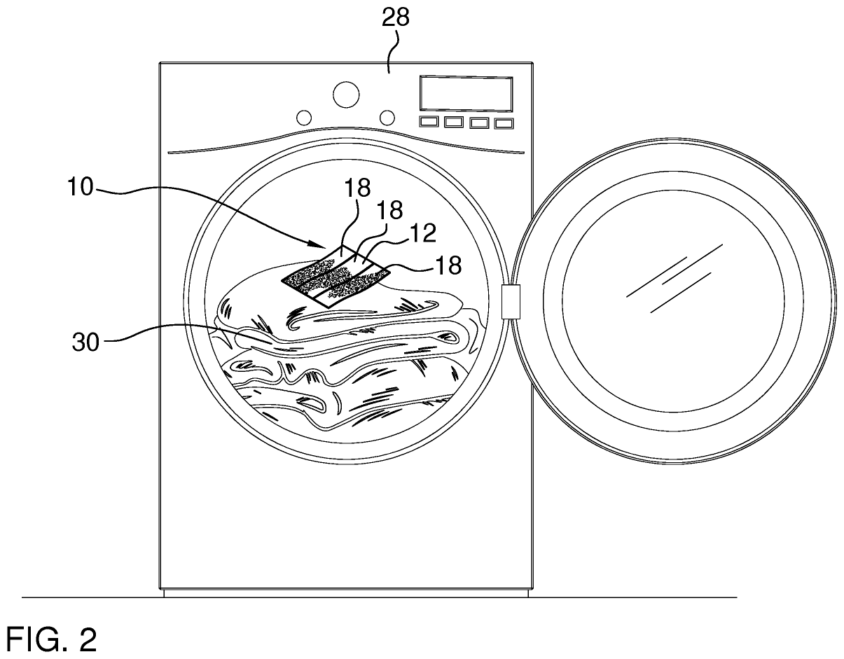

With reference now to the drawings, and in particular to FIGS. 1 through 2 thereof, a new dryer sheet embodying the principles and concepts of an embodiment of the disclosure and generally designated by the reference numeral 10 will be described.

As best illustrated in FIGS. 1 through 2, the dryer sheet 10 generally comprises a substrate 12 comprising a biodegradable fabric. The biodegradable fabric is selected from a group consisting of a cotton fabric and a bamboo fabric. In some embodiments, another conventional biodegradable fabric may be used, such as one formed of hemp, aloe vera fibers, or the like. The substrate 12 has a rectangular planar shape and a pair of creases 14 formed thereon to facilitate folding the substrate 12 in a trifold fashion. The creases 14 of the pair of creases 14 are oriented parallel to each other and parallel to each one of a pair of longitudinal edges 16 of the substrate 12. The pair of creases 14 define three sections 18 of the substrate 12 which are equal in size to each other.

A fabric softening agent 20 permeates the substrate 12 and is biodegradable. The fabric softening agent 20 is uniformly distributed in the substrate 12. The fabric softening agent 20 comprises a quaternary ammonium compound, which is a conventional substance used to soften fabrics. Quaternary ammonium compounds contain positively charged molecules which bind to negatively charged fabrics to receive electrons from the negatively charged fabrics, thus cancelling out the negative charge. It is known to the prior art that various quaternary ammonium compounds are biodegradable, including in particular ones formed from a tallow source or a vegetable source. Examples of such biodegradable quaternary ammonium compounds can be found, for example, in U.S. Pat. No. 7,947,644, the disclosure of which is incorporated herein by reference.

A moisturizer 22 permeates the substrate 12 and is biodegradable. The moisturizer 22 is uniformly distributed on the substrate 12. The moisturizer 22 acts to lubricate fabrics and may also act to transfer from the fabrics to a user's skin when worn by the user to treat the user's skin. The moisturizer 22 comprises aloe vera but may include other conventional biodegradable lubricating materials. An antibacterial agent 24 is adhered to the substrate 12 and is biodegradable. The antibacterial agent 24 comprises a plurality of evenly spaced deposits 26 adhered to the substrate 12. The antibacterial agent 24 is selected from a group consisting of acacia, echinacea, sage, goldenseal, juniper, and wormwood, but the antibacterial agent 24 may comprise other conventional biodegradable antibacterial agents 24. The antibacterial agent 24 may also have antiviral, antifungal, and other antimicrobial properties. In embodiments without a separate antibacterial agent 24, antibacterial properties of the aloe vera moisturizer 22 may act in the same manner as the antibacterial agent 24.

Fragrance imparting substances may also be adhered to the substrate 12. The fragrance imparting substances may be selected from biodegradable materials including avocado extract, green tea, white tea, lavender oil, grapefruit oil, jasmine flower, vetiver root, and turmeric. More than 90% of the dryer sheet 10 by weight comprises biodegradable substances.

In use, the dryer sheet 10 is placed in a dryer 28 along with laundry 30. The dryer 28 is operated to move and heat the laundry 30 to dry the laundry 30. Negative electric charges which accumulate on the laundry 30 due to the triboelectric effect or other source cause the positively charged fabric softening agent 20 to release from the substrate 12 and bond to the laundry 30, thus cancelling out the electric charges. The moisturizer 22, the antibacterial agent 24, and any fragrance imparting substances also transfer to the laundry 30 as a result of the dryer sheet 10 rubbing against the laundry 30. Heat generated by the dryer 28 may promote a release of the moisturizer 22, the antibacterial agent 24, and the fragrance imparting substances from the substrate 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dryer sheet comprising:
a substrate comprising a biodegradable fabric; and
a fabric softening agent being coupled to the substrate, the fabric softening agent being biodegradable; and
an antibacterial agent being coupled to the substrate, the antibacterial agent being biodegradable.

2. The dryer sheet of claim 1, wherein the biodegradable fabric comprises a cotton fabric.

3. The dryer sheet of claim 1, wherein the biodegradable fabric comprises a bamboo fabric.

4. The dryer sheet of claim 1, wherein the substrate has a rectangular planar shape, the substrate having a pair of creases formed thereon to facilitate folding the substrate in a trifold fashion.

5. The dryer sheet of claim 4, wherein the creases of the pair of creases are oriented parallel to each other, the pair of creases being oriented parallel to each one of a pair of longitudinal edges of the substrate.

6. The dryer sheet of claim 5, wherein the pair of creases defines three sections of the substrate which are equal in size to each other.

7. The dryer sheet of claim 1, wherein the fabric softening agent comprises a quaternary ammonium compound.

8. The dryer sheet of claim 1, wherein the fabric softening agent is uniformly distributed in the substrate.

9. The dryer sheet of claim 1, wherein the antibacterial agent comprises acacia.

10. The dryer sheet of claim 1, wherein the antibacterial agent comprises echinacea.

11. The dryer sheet of claim 1, wherein the antibacterial agent comprises sage.

12. The dryer sheet of claim 1, wherein the antibacterial agent comprises goldenseal.

13. The dryer sheet of claim 1, wherein the antibacterial agent comprises juniper.

14. The dryer sheet of claim 1, wherein the antibacterial agent comprises wormwood.

15. The dryer sheet of claim 1, wherein the antibacterial agent comprises a plurality of evenly spaced deposits coupled to the substrate.

16. The dryer sheet of claim 1, further comprising a moisturizer being coupled the substrate, the moisturizer being biodegradable.

17. The dryer sheet of claim 16, wherein the moisturizer comprises aloe vera.

18. The dryer sheet of claim 16, wherein the moisturizer is uniformly distributed on the substrate.

19. A dryer sheet comprising:
a substrate comprising a biodegradable fabric, the biodegradable fabric being selected from a group consisting of a cotton fabric and a bamboo fabric, the substrate having a rectangular planar shape, the substrate having a pair of creases formed thereon to facilitate folding the substrate in a trifold fashion, the pair of creases being oriented parallel to each other, the pair of creases being oriented parallel to each one of a pair of longitudinal edges of the substrate, the pair of creases defining three sections of the substrate which are equal in size to each other;
a fabric softening agent permeating the substrate, the fabric softening agent being biodegradable, the fabric softening agent comprising a quaternary ammonium compound, the fabric softening agent being uniformly distributed in the substrate;
a moisturizer permeating the substrate, the moisturizer being biodegradable, the moisturizer comprising aloe vera, the moisturizer being uniformly distributed on the substrate; and
an antibacterial agent being adhered to the substrate, the antibacterial agent being biodegradable, the antibacterial agent being selected from a group consisting of acacia, echinacea, sage, goldenseal, juniper, and wormwood, the antibacterial agent being comprising a plurality of evenly spaced deposits adhered to the substrate.
